(19) United States
(12) Patent Application Publication
(10) Pub. No.: US 2026/0328941 A1
(43) Pub. Date: Oct. 22, 2026

(54) ORTHOGONAL PHASE MODULATION LIDAR

(71) Applicant: Intel Corporation, Santa Clara, CA (US)

(72) Inventors: Fei Li, Beijing (CN); Ling Liu, Beijing (CN); Xiangbin Wu, Beijing (CN); Anbang Yao, Beijing (CN); Lidan Zhang, Beijing (CN)

(21) Appl. No.: 19/106,786

(22) PCT Filed: Sep. 29, 2022
(86) PCT No.: PCT/CN2022/122452

§ 371 Date: Feb. 26, 2025

(51) Int. Cl. G01S 17/32; G01S 7/481

(52) U.S. Cl. CPC G01S 17/32; G01S 7/4815

(57) ABSTRACT

An apparatus, including an electro-optical modulating means is for phase modulating a light signal with a range measurement code and a light beam isolation code; an electro-optical detecting means for receiving a reflected light signal of the phase modulated light signal reflected by an object and converting the received reflected light signal into an electronic data signal; and processor means for correlating the electronic data signal with the light beam isolation code and the range measurement code to obtain a range to the object.

### BACKGROUND

Light detection and ranging (lidar) is a remote sensing method which uses light to measure range (distance). Lidar is widely used in autonomous vehicles (AVs). In traffic scenes with numerous AVs, lidar light pulses from different AVs are not readily distinguishable. Such light pulse interference increases a risk of faulty range detection leading to more accident.

### BRIEF DESCRIPTION OF THE DRAWINGS

FIG. 1 illustrates a schematic diagram of an apparatus in accordance with aspects of the present disclosure.

FIG. 2 illustrates a flowchart of a method in accordance with aspects of the disclosure.

FIGS. 3A-3C illustrate graphs related to a performance example of the method and apparatus in accordance with aspects of the disclosure.

### DESCRIPTION OF THE ASPECTS

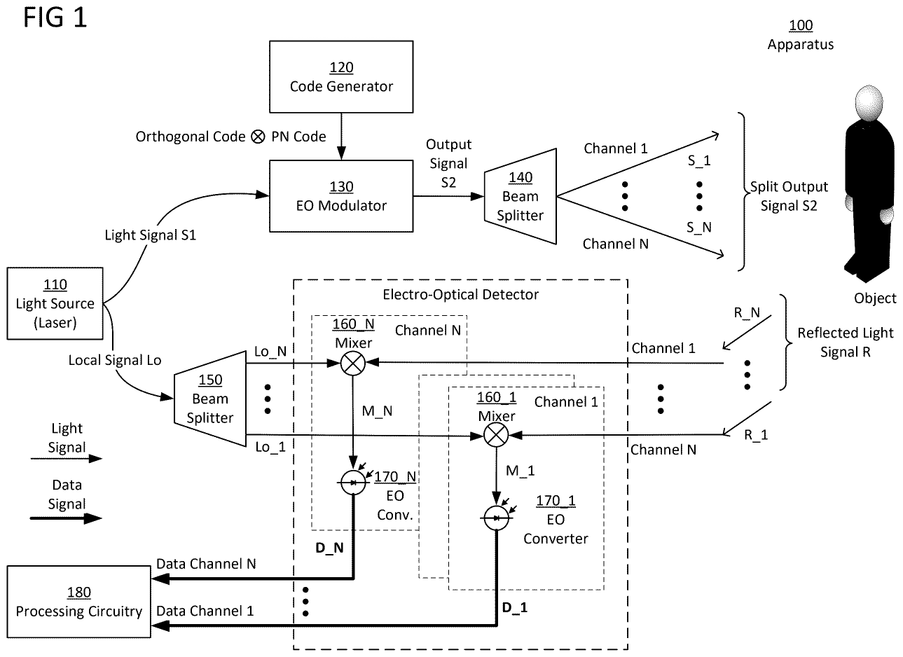

FIG. 1 illustrates a schematic diagram of an apparatus 100 in accordance with aspects of the preset disclosure.

The apparatus 100 comprises a light source 110, a code generator 120, an electro-optical modulator 130, a first beam splitter 140, a second beam splitter 150, an electro-optical detector comprising a mixer 160 and an electro-optical converter 170, and processing circuitry 180. The mixer 160 may comprise one or more mixers (160_1 . . . 160_N). Similarly, the electro-optical converter 170 may comprise one or more electro-optical converters (170_1 . . . 170_N).

By way of overview, the light source (e.g., a laser) transmits a light signal S1 to the electro-optical modulator 130, which phase modulates the light signal S1 to transmit output signal S2. The output signal S2 propagates through space and may be reflected by an object as reflected light signal R. The reflected light signal R may include a time delay, which corresponds with a distance to the object. The mixer 160 mixes the reflected light signal R in the optical domain with a local signal Lo from the coherent light source 110 to output a mixed signal M. The electric-optical converter 170 converts the mixed signal M into an electrical data signal D. Finally, the processing circuitry 180 processes the electrical data signal D to determine, based on the time delay, the range to the object.

The phase modulation of the electro-optical modulator 130 is based on two codes-a range measurement code and a light beam isolation code. The range measurement code may be a pseudorandom number (PN) code. The light beam isolation code is a mutual orthogonal code, such as a Walsh code, to isolate reflected light signals from one another. The PN code, orthogonal code, and Walsh code are merely examples not necessarily limiting.

With this overview in mind, a more detailed explanation of the operation of the apparatus 100 of FIG. 1 follows.

The light source 110 is configured to generate a light signal S1 and a local light signal Lo, with the light signal S1 generally including a majority of the power. The light source 110 may be a laser source and is coherent, and the apparatus 100 may be a lidar apparatus. The light signal S1 and local signal Lo are represented as:

S1(t)=A*cos(ωt) and (Equation 1)

Lo(t)=B*cos(ωt), (Equation 2)

where ω is the light source frequency, and A and B are amplitudes.

The code generator 120 is configured to generate a range measurement code and a light beam isolation code. The range measurement code may be a PN code or the like. The light beam isolation code may be an orthogonal code (e.g., a Walsh code). An orthogonal code is a spreading code having good autocorrelation properties, but poor cross correlation properties. Orthogonal coding is designed to expand a vertical or horizontal field-of-view (FoV). Vertical FoV is limited in lidar applications because lasers have a relatively narrow angle of divergence.

For ease of explanation, the much of the disclosure refers to the range measurement code as a PN code, and the light beam isolation code as an orthogonal code, though this is not necessarily meant to be limiting. The apparatus 100 is described in terms of a lidar apparatus. And the mixer 160, which may comprise a plurality of mixers (160_1 . . . 160_N), and the electro-optical converter 170, which may comprise a plurality of electro-optical converters (170_1 . . . 170_N), may be referred to simply as mixer 160 and electro-optical converter 170, respectively.

The PN code sequence is represented as:

$$P N ( t ) = {\sum }_{k = 1}^{L} {C}_{k} * δ ( t - kT ) , \qquad ( Equation 3 )$$

where T is chip duration, L is PN code length, and {C₁, Cₖ . . . C_{L}} are PN code chips.

The orthogonal code (OC) sequence is represented as:

$$O {C}_{j} ( t ) = {\sum }_{k = 1}^{L 1} {Q}_{k} * δ ( t - k T ) , \qquad ( Equation 4 )$$

where T is chip duration, L1 is OC length, j is the j-th sequence of the orthogonal code, and {Q₁, Qₖ . . . Q_{L1}} are orthogonal code chips. The number of orthogonal codes in the sequence may generally correspond with the number of channels N.

The PN code sequence PN(t) is for range measurement, and the orthogonal code sequence OC(t) is for lidar isolation and identification. Each lidar source may be assigned a mutual orthogonal code sequence randomly, and may be re-assigned periodically, in order to avoid conflict. Between lidar sources A combination of the PN code sequence PN(t) and the orthogonal code sequence OC(t) as the phase modulation information is represented as:

$${P}_{j} ( t ) = \{ {\sum }_{k = 1}^{L 1} {Q}_{k} * δ ( t - k T ) \} ⊗ \{ {\sum }_{k = 1}^{L} {C}_{k} * δ ( t - k T ) \} \qquad ( Equation 5 )$$

The electro-optical modulator 130 is configured to phase modulate the light signal S1 with the PN code sequence and the orthogonal code sequence into output signal S2. To obtain a wider vertical detection angle, the first beam splitter 140 divides the output signal S2 into N channels. More specifically, the first beam splitter 140 is configured to split the phase modulated light signal S2 into a plurality of phase modulated light beam signals S_1-S_N to be transmitted over respective channels 1-N. Correspondingly, the electro-optical modulator 130 modulates the plurality of phase modulated light beam signals S_1-S_N with a plurality of respective orthogonal codes of the orthogonal code sequence OC (t). The modulated output signal S2 is represented as:

S2ⱼ(t)=A*cos(ωt+Pⱼ(t)π), (Equation 6)

where j is the j-th sequence of the orthogonal code sequence.

After a time delay, the electro-optical detector is configured to receive over the N channels a reflected light signal R (comprising reflected light beams R_1 . . . . R_N), which is the phase modulated light signal S2 reflected by the object. To simplify the analysis, it is assumed there is no attenuation during the propagation. The reflected light signal R is represented as:

$${R \_ k}_{j} ( t ) = \frac{A}{N} * cos ( ω ( t + Δ {t}_{k} ) + {P}_{j} ( t + Δ {t}_{k} ) π ) , \qquad ( Equation 7 )$$

where k is the k-th receiver, and Δt_k is the delay time.

The mixer 160 is configured to mix the received reflected light signal R coherently with the local light signal Lo and output a mixed light signal M. More specifically, the second beam splitter 150 is configured to split the local light signal Lo into a plurality of local light beam signals Lo_1-Lo_N. The plurality of mixers 160_1-160_N is configured mix the plurality of local light signals Lo_1-Lo_N with the respective reflected light signals R_1-R_N in the optical domain, with the output mixed light signal M (M_1 . . . . M_N) represented as:

$${M}_{kj ( t )} = {R}_{{k}_{j}} ( t ) * L {o}_{k ( t )} = \frac{A}{N} * cos ( ω ( t + Δ {t}_{k} ) + {P}_{j} ( t + Δ {t}_{k} ) π ) * \frac{B}{N} * cos ( ω t ) = \frac{A B}{{N}^{2}} \{ cos ( ω t + ω ( t + Δ {t}_{k} ) + {P}_{j} ( t + Δ {t}_{k} ) π ) + cos ( ω ( t + Δ {t}_{k} ) + {P}_{j} ( t + Δ {t}_{k} ) π - ω t ) \} = \frac{A B}{{N}^{2}} \{ cos ( 2 ω t + ( ωΔ {t}_{k} ) + {P}_{j} ( τ + Δ {t}_{k} ) π ) + cos ( ( ω Δ {t}_{k} ) + {P}_{j} ( t + Δ {t}_{k} ) π ) \} . \qquad ( Equation 8 )$$

2ωt is beyond the response frequency range of apparatus 100, and the DC signal with no phase information is filtered. The output of the mixer 160 is M′ₖ₍ₜ₎ with a photoelectric coefficient ε is represented as:

$${M}_{kj ( t )}^{′} = ε \frac{A B}{{N}^{2}} cos ( {P}_{j} ( t + Δ {t}_{k} ) π ) = ε \frac{A B}{{N}^{2}} {P}_{j} ( t + Δ {t}_{k} ) . \qquad ( Equation 9 )$$

The Pⱼ(t+Δtₖ) sequence is the phase modulation information (see Equation 5 above) with a time delay Δtₖ corresponding with the range information.

Next, the electro-optical converter 170 is configured to convert the mixed light signal M′ into the electronic data signals D (D_1 . . . . D_N). The term “data” as used herein may be understood to include information in any suitable analog or digital form.

The processing circuitry 180 is configured to correlate the electronic data signal D with the orthogonal codes to filter out any interfering signals, and then correlate this filtered result with the PN code to obtain the range. More specifically, the processing circuitry 180 applies a correlation on mixed signal M′ₖⱼ₍ₜ₎ using orthogonal code sequence OCₘ(t), m=1,2 . . . . M. With mutual orthogonality, if the reflected light signal R is coded with the same OC(t) sequence, the resulting correlation will be PN(t). Otherwise, the result will be zero, as follows:

$${M}_{kj ( t )}^{′} ⊗ {OC}_{m} ( t ) = \{ \begin{matrix}ε \frac{AB}{{N}^{2}} PN ( t + Δ {t}_{k} ) & if m = j \\ 0 & if m \neq j\end{matrix} \} \qquad ( Equation 10 )$$

The processing circuitry 180 applies another correlation on this result with the PN code sequence PN(t). The energy peak of this result has a shift from an original location representing the time delay.

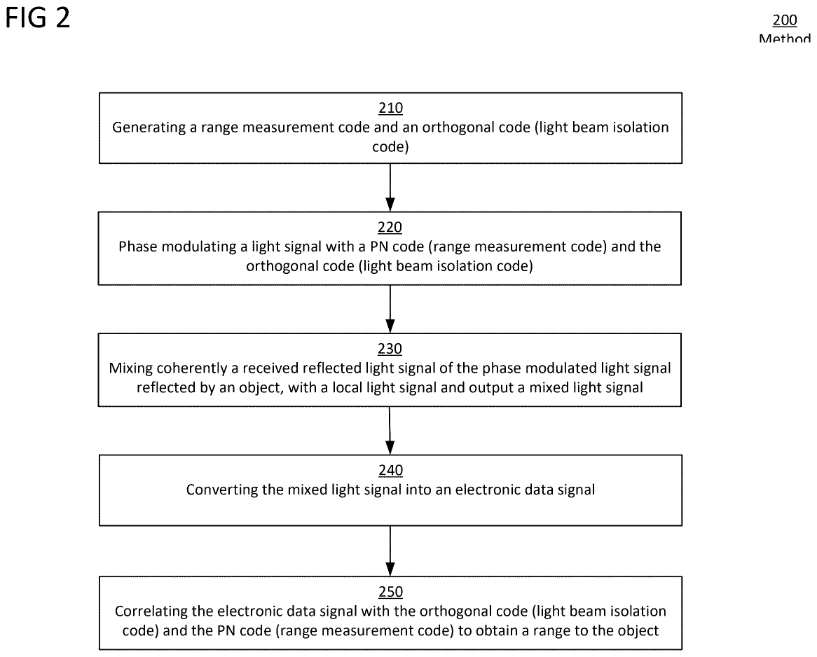

FIG. 2 illustrates a flowchart of a method 200 in accordance with aspects of the disclosure.

A code generator 120, in Step 210, generates a PN code (range measurement code) and an orthogonal code (light beam isolation code).

An electro-optical modulator 130, in Step 220, phase modulates a light signal S1 with the PN code (range measurement code) and the orthogonal code (light beam isolation code).

A mixer 170, in Step 230, mixes coherently an electro-optical detector, a received reflected light signal R with a local light signal and output a mixed light signal M. The reflected light signal R is the phase modulated light signal reflected by an object.

An electro-optical converter 170, in Step 240, converts the electro-optical detector, the mixed light signal M into the electronic data signal D.

Processing circuitry 180, in Step 250, correlates the electronic data signal D with the orthogonal code (light beam isolation code) and the PN code (range measurement code) to obtain a range to the object.

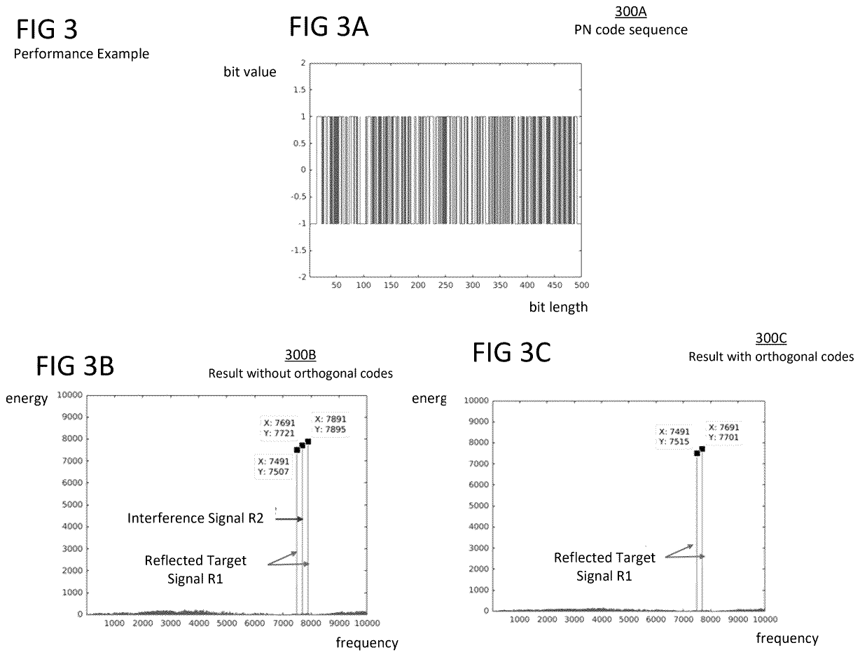

FIGS. 3A-3C illustrate graphs related to a performance example 300 of the method and apparatus in accordance with aspects of the disclosure. FIG. 3A illustrates a graph 300A of a PN code sequence. FIG. 3B illustrates a graph 300B of detection result without orthogonal codes. FIG. 3C illustrates a graph 300C of a detection result with orthogonal codes.

This performance example is of a PN code sequence and two-bit mutual orthogonal codes. The PN code length is 8191 (13^{th} order), and the mutual orthogonal codes are OC1 (1,1) and OC2 (1, −1). OC1 is the orthogonal code for a target lidar signal, and OC2 is the orthogonal code for an interference signal.

The initial PN codes are modulated with OC1 and OC2 separately as the transmitted target signal T1(t) and the transmitted interference signal T2(t).

To simulate two actual objects, the transmitted target signal T1(t) is delayed by Δt_1 and Δt_2. These delays are added as the actual reflected signal R1 represented as:

R1(t)=T1(t+Δt_1)+T1(t+Δt_2), (Equation 11)

and the reflected signal R1(t) is interfered by the transmitted interference signal T2(t+Δt_3). The target reflected signal is represented as:

Reflect(t)=T1(t+Δt_1)+T1(t+Δt_2)+T2(t+Δt_3). (Equation 12)

Here, Δt₁=500 chips, Δt₂=700 chips, and Δt₃=300 chips.

FIG. 3B shows a graph 300B without orthogonal codes. There is signal aliasing, and the reflected signals R from other sources cannot be determined. The reflected interference signal R2 is clearly shown.

FIG. 3C shows a graph 300C using orthogonal codes, and only the target reflected signal R1 is demodulated. The reflected interference signal R2 is filtered out

The aspects of this disclosure result in good interference rejection. This leads to safer driving scenarios. And detection range is mainly impacted by the energy loss in propagation. Most direct detection lidar method depend only on the reflected light signal's amplitude to determine range. This disclosure introduces a coherent method with a local laser signal. The local laser signal's power enlarges the mixed light signal resulting in a larger range detection.

The term “processing circuitry” as, for example, used herein may be understood as any kind of technological entity that allows handling of data. The data may be handled according to one or more specific functions executed by the processing circuitry. Further, processing circuitry as used herein may be understood as any kind of circuit, e.g., any kind of analog or digital circuit. A processing circuitry may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processing circuitries or logic circuits detailed herein may be realized as a single entity with equivalent functionality or the like, and conversely that any single processing circuitry or logic circuit detailed herein may be realized as two (or more) separate entities with equivalent functionality or the like.

Unless explicitly specified, the term “transmit” encompasses both direct (point-to-point) and indirect transmission (via one or more intermediary points). Similarly, the term “receive” encompasses both direct and indirect reception.

Each processing circuitry may include various types of hardware-based processing devices. By way of example, each processing circuitry may include a microprocessor, pre-processors (such as an image pre-processor), graphics processors, a central processing unit (CPU), support circuits, digital signal processors, integrated circuits, memory, or any other types of devices suitable for running applications and for image processing and analysis. In some aspects, each processing circuitry may include any type of single or multi-core processor, mobile device microcontroller, central processing unit, etc. These processing circuitry types may each include multiple processing units with local memory and instruction sets.

Any of the processing circuitries disclosed herein may be configured to perform certain functions in accordance with program instructions which may be stored in a memory of one or more memories. In other words, a memory of the one or more memories may store software that, when executed by a processor (e.g., by the one or more processing circuitries), controls the operation of a system. The one or more memories may include any number of random access memories, read only memories, flash memories, disk drives, optical storage, tape storage, removable storage and other types of storage.

The term “autonomous vehicle” may describe a vehicle capable of implementing at least one navigational change without driver input. A navigational change may describe or include a change in one or more of steering, braking, or acceleration/deceleration of the vehicle. A vehicle may be described as autonomous even in case the vehicle is not fully automatic (for example, fully operational with driver or without driver input). Autonomous vehicles may include those vehicles that can operate under driver control during certain time periods and without driver control during other time periods. Autonomous vehicles may also include vehicles that control only some aspects of vehicle navigation, such as steering (e.g., to maintain a vehicle course between vehicle lane constraints) or some steering operations under certain circumstances (but not under all circumstances), but may leave other aspects of vehicle navigation to the driver (e.g., braking or braking under certain circumstances). Autonomous vehicles may also include vehicles that share the control of one or more aspects of vehicle navigation under certain circumstances (e.g., hands-on, such as responsive to a driver input) and vehicles that control one or more aspects of vehicle navigation under certain circumstances (e.g., hands-off, such as independent of driver input). Autonomous vehicles may also include vehicles that control one or more aspects of vehicle navigation under certain circumstances, such as under certain environmental conditions (e.g., spatial areas, roadway conditions). In some aspects, autonomous vehicles may handle some or all aspects of braking, speed control, velocity control, and/or steering of the vehicle. An autonomous vehicle may include those vehicles that can operate without a driver. The level of autonomy of a vehicle may be described or determined by the Society of Automotive Engineers (SAE) level of the vehicle (e.g., as defined by the SAE, for example in SAE J3016 2018: Taxonomy and definitions for terms related to driving automation systems for on road motor vehicles) or by other relevant professional organizations. The SAE level may have a value ranging from a minimum level, e.g. level 0 (illustratively, substantially no driving automation), to a maximum level, e.g. level 5 (illustratively, full driving automation). In addition to autonomous vehicles, the present invention may be applicable in other autonomous systems including autonomous robots, drones, Unmanned Aerial Vehicles, etc.

The techniques of this disclosure may also be described in the following examples.

Example 1. An apparatus, comprising: an electro-optical modulating means for phase modulating a light signal with a range measurement code and a light beam isolation code; an electro-optical detecting means for receiving a reflected light signal of the phase modulated light signal reflected by an object and convert the received reflected light signal into an electronic data signal; and processing means for correlating the electronic data signal with the light beam isolation code and the range measurement code to obtain a range to the object.

Example 2. The apparatus of example 1, wherein the processing means is further for correlating the electronic data signal with the light beam isolation code to filter out any interfering signal, and then correlating this filtered result with the range measurement code to obtain the range.

Example 3. The apparatus of any one or more of examples 1-2, wherein an energy peak of the correlated filtered result has a time delay corresponding with the range.

Example 4. The apparatus of any one or more of examples 1-3, further comprising: a first beam splitting means for splitting the phase modulated light signal into a plurality of phase modulated light beam signals to be transmitted over respective channels, wherein the electro-optical modulating means is further for modulating the plurality of phase modulated light beam signals with a plurality of respective light beam isolation codes.

Example 5. The apparatus of any one or more of examples 1-4, further comprising: a second beam splitting means for splitting a local light signal into a plurality of local light beam signals; and a plurality of mixing means within the electro-optical detecting means for mixing respective reflected light signals of the plurality of phase modulated light beam signals with the respective plurality of local light signals.

Example 6. The apparatus of any one or more of examples 1-5, wherein the electro-optical detecting means comprises: a mixing means for coherently mixing the received reflected light signal with a local light signal and outputting a mixed light signal.

Example 7. The apparatus of any one or more of examples 1-6, wherein the electro-optical detector further comprises: an electro-optical converting means for converting the mixed light signal into the electronic data signal.

Example 8. The apparatus of any one or more of examples 1-7, further comprising: a lighting means for generating the light signal and the local light signal.

Example 9. The apparatus of any one or more of examples 1-8, wherein the lighting means is a laser, and the apparatus is a lidar (light detection and ranging) apparatus.

Example 10. The apparatus of any one or more of examples 1-9, further comprising: a code generating means for generating the range measurement code and the light beam isolation code.

Example 11. The apparatus of any one or more of examples 1-10, wherein the electro-optical modulating means is further for assigning the light beam isolation code randomly.

Example 12. The apparatus of any one or more of examples 1-11, wherein the electro-optical modulating means is further for reassigning the light beam isolation code periodically.

Example 13. The apparatus of any one or more of examples 1-12, wherein the range measurement code is a pseudorandom number.

Example 14. The apparatus of any one or more of examples 1-13, wherein the light beam isolation code is an orthogonal code.

Example 15. An autonomous system, comprising: an electro-optical modulator for phase modulating a light signal with a range measurement code and a light beam isolation code; a detector for receiving a reflected light signal of the phase modulated light signal reflected by an object, and a convertor for converting the received reflected light signal into an electronic data signal; and a processor for correlating the electronic data signal with the light beam isolation code and the range measurement code to obtain a range to the object.

Example 16. The autonomous system of example 15, wherein the processor further correlates the electronic data signal with the light beam isolation code to filter out any interfering signal, and then correlate this filtered result with the range measurement code to obtain the range.

Example 17. The autonomous system of any one or more of examples 15-16, wherein an energy peak of the correlated filtered result has a time delay corresponding with the range.

Example 18. The autonomous system of any one or more of examples 15-17, further comprising: a splitter for splitting the phase modulated light signal into a plurality of phase modulated light beam signals to be transmitted over respective channels; and wherein the electro-optical modulator further modulates the plurality of phase modulated light beam signals with a plurality of respective light beam isolation codes.

Example 19. The autonomous system of any one or more of examples 15-18, wherein the splitter further splits a local light signal into a plurality of local light beam signals; and a mixer, within the electro-optical detector, for mixing respective reflected light signals of the plurality of phase modulated light beam signals with the respective plurality of local light signals.

Example 20. The autonomous system of any one or more of examples 15-19 wherein the mixer further mixes coherently the received reflected light signal with a local light signal and output a mixed light signal.

Example 21. The autonomous system of any one or more of examples 15-20, further comprising: an electro-optical converter for converting the mixed light signal into the electronic data signal.

Example 22. The autonomous system of any one or more of examples 15-21, further comprising: a code generator for generating the range measurement code and the light beam isolation code.

Example 23. The autonomous system of any one or more of examples 15-22, wherein the electro-optical modulator further reassigns the light beam isolation code periodically.

Example 24. The autonomous system of any one or more of examples 15-23, wherein the light signal is a laser signal, the range measurement code is a pseudorandom number, or the light beam isolation code is an orthogonal code.

Example 25. A component of a system, comprising: a processor; and a non-transitory computer-readable storage medium including instructions that, when executed by the processor, cause the processor to perform the method of any of examples 15-25.

Example 26. An apparatus, comprising: an electro-optical modulator configured to phase modulate a light signal with a range measurement code and a light beam isolation code; an electro-optical detector configured to receive a reflected light signal of the phase modulated light signal reflected by an object and convert the received reflected light signal into an electronic data signal; and processing circuitry configured to correlate the electronic data signal with the light beam isolation code and the range measurement code to obtain a range to the object.

Example 27. The apparatus of example 26, wherein the processing circuitry is further configured to correlate the electronic data signal with the light beam isolation code to filter out any interfering signal, and then correlate this filtered result with the range measurement code to obtain the range.

Example 28. The apparatus of example 27, wherein an energy peak of the correlated filtered result has a time delay corresponding with the range.

Example 29. The apparatus of example 26, further comprising: a first beam splitter configured to split the phase modulated light signal into a plurality of phase modulated light beam signals to be transmitted over respective channels, wherein the electro-optical modulator is further configured to modulate the plurality of phase modulated light beam signals with a plurality of respective light beam isolation codes.

Example 30. The apparatus of example 29, further comprising: a second beam splitter configured to split a local light signal into a plurality of local light beam signals; and a plurality of mixers configured within the electro-optical detector to mix respective reflected signals of the plurality of phase modulated light beam signals with the respective plurality of local light signals.

Example 31. The apparatus of example 26, wherein the electro-optical detector comprises: a mixer configured to coherently mix the received reflected light signal with a local light signal and output a mixed light signal.

Example 32. The apparatus of example 31, wherein the electro-optical detector further comprises: an electro-optical converter configured to convert the mixed light signal into the electronic data signal.

Example 33. The apparatus of example 31, further comprising: a light source configured to generate the light signal and the local light signal.

Example 34. The apparatus of example 33, wherein the light source is a laser, and the apparatus is a lidar (light detection and ranging) apparatus.

Example 35. The apparatus of example 26, further comprising: a code generator configured to generate the range measurement code and the light beam isolation code.

Example 36. The apparatus of example 26, wherein the electro-optical modulator is further configured to assign the light beam isolation code randomly.

Example 37. The apparatus of example 26, wherein the electro-optical modulator is further configured to reassign the light beam isolation code periodically.

Example 38. The apparatus of example 26, wherein the range measurement code is a pseudorandom number.

Example 39. The apparatus of example 26, wherein the light beam isolation code is an orthogonal code.

Example 40. An autonomous system, comprising: an electro-optical modulator configured to phase modulate a light signal with a range measurement code and a light beam isolation code; an electro-optical detector configure to receive a reflected light signal of the phase modulated light signal reflected by an object, and convert the received reflected light signal into an electronic data signal; and processing circuitry configured to correlate, the electronic data signal with the light beam isolation code and the range measurement code to obtain a range to the object.

Example 41. The autonomous system of example 40, wherein the processing circuitry is further configured to correlate the electronic data signal with the light beam isolation code to filter out any interfering signal, and then correlate this filtered result with the range measurement code to obtain the range.

Example 42. The autonomous system of example 41, wherein an energy peak of the correlated filtered result has a time delay corresponding with the range.

Example 43. The autonomous system of example 40, further comprising: a first beam splitter configured to split the phase modulated light signal into a plurality of phase modulated light beam signals to be transmitted over respective channels; and wherein by the electro-optical modulator is further configured to modulate the plurality of phase modulated light beam signals with a plurality of respective light beam isolation codes.

Example 44. The autonomous system of example 43, further comprising: a second beam splitter configured to split a local light signal into a plurality of local light beam signals; and a plurality of mixers, within the electro-optical detector, configured to mix respective reflected signals of the plurality of phase modulated light beam signals with the respective plurality of local light signals.

Example 45. The autonomous system of example 40, further comprising: a mixer, of the electro-optical detector, configured to coherently mix the received reflected light signal with a local light signal and output a mixed light signal.

Example 46. The autonomous system of example 45, further comprising: an electro-optical converter, of the electro-optical detector, configured to convert the mixed light signal into the electronic data signal.

Example 47. The autonomous system of example 40, further comprising: a code generator configured to convert the range measurement code and the light beam isolation code.

Example 48. The autonomous system of example 40, wherein the electro-optical modulator is further configured to assign the light beam isolation code randomly.

Example 49. The autonomous system of example 45, wherein the electro-optical modulator is further configured to reassign the light beam isolation code periodically.

Example 50. The autonomous system of example 45, wherein the light signal is a laser signal, the range measurement code is a pseudorandom number, or the light beam isolation code is an orthogonal code.

Example 51. A method, comprising: phase modulating, by an electro-optical modulator, a light signal with a range measurement code and a light beam isolation code; receiving, by an electro-optical detector, a reflected light signal of the phase modulated light signal reflected by an object, and converting the received reflected light signal into an electronic data signal; and correlating, by processing circuitry, the electronic data signal with the light beam isolation code and the range measurement code to obtain a range to the object.

Example 52. The method of example 51, further comprising: correlating, by the processing circuitry, the electronic data signal with the light beam isolation code to filter out any interfering signal, and then correlating this filtered result with the range measurement code to obtain the range.

Example 53. The method of any one or more of examples 51-52, wherein an energy peak of the correlated filtered result has a time delay corresponding with the range.

Example 54. The method of any one or more of examples 51-53, further comprising: splitting, by a first beam splitter, the phase modulated light signal into a plurality of phase modulated light beam signals to be transmitted over respective channels; and modulating, by the electro-optical modulator, the plurality of phase modulated light beam signals with a plurality of respective light beam isolation codes.

Example 55. The method of any one or more of examples 51-54, further comprising: splitting, by a second beam splitter, a local light signal into a plurality of local light beam signals; and mixing, by a plurality of mixers configured within the electro-optical detector, respective reflected signals of the plurality of phase modulated light beam signals with the respective plurality of local light signals.

Example 56. The method of any one or more of examples 51-55, further comprising: mixing coherently, by a mixer of the electro-optical detector, the received reflected light signal with a local light signal and output a mixed light signal.

Example 57. The method of any one or more of examples 51-56, further comprising: converting, by an electro-optical converter of the electro-optical detector, the mixed light signal into the electronic data signal.

Example 58. The method of any one or more of examples 51-57, further comprising: generating, by a code generator, the range measurement code and the light beam isolation code.

Example 59. The method of any one or more of examples 51-58, further comprising: assigning, by the electro-optical modulator, the light beam isolation code randomly.

Example 60. The method of any one or more of examples 51-59, further comprising: reassigning, by the electro-optical modulator, the light beam isolation code periodically.

Example 61. The method of any one or more of examples 51-60, wherein the light signal is a laser signal, the range measurement code is a pseudorandom number, or the light beam isolation code is an orthogonal code.

While the foregoing has been described in conjunction with exemplary aspect, it is understood that the term “exemplary” is merely meant as an example, rather than the best or optimal. Accordingly, the disclosure is intended to cover alternatives, modifications and equivalents, which may be included within the scope of the disclosure.

Although specific aspects have been illustrated and described herein, it will be appreciated by those of ordinary skill in the art that a variety of alternate and/or equivalent implementations may be substituted for the specific aspects shown and described without departing from the scope of the present application. This application is intended to cover any adaptations or variations of the specific aspects discussed herein.

1-25. (canceled)

26. An apparatus, comprising:
an electro-optical modulator configured to phase modulate a light signal with a range measurement code and a light beam isolation code;
an electro-optical detector configured to receive a reflected light signal of the phase modulated light signal reflected by an object and convert the received reflected light signal into an electronic data signal; and
processing circuitry configured to correlate the electronic data signal with the light beam isolation code and the range measurement code to obtain a range to the object.

27. The apparatus of claim 26, wherein the processing circuitry is further configured to correlate the electronic data signal with the light beam isolation code to filter out any interfering signal, and then correlate this filtered result with the range measurement code to obtain the range.

28. The apparatus of claim 27, wherein an energy peak of the correlated filtered result has a time delay corresponding with the range.

29. The apparatus of claim 26, further comprising:
a first beam splitter configured to split the phase modulated light signal into a plurality of phase modulated light beam signals to be transmitted over respective channels,
wherein the electro-optical modulator is further configured to modulate the plurality of phase modulated light beam signals with a plurality of respective light beam isolation codes.

30. The apparatus of claim 29, further comprising:
a second beam splitter configured to split a local light signal into a plurality of local light beam signals; and
a plurality of mixers configured within the electro-optical detector to mix respective reflected signals of the plurality of phase modulated light beam signals with the respective plurality of local light signals.

31. The apparatus of claim 26, wherein the electro-optical detector comprises:
a mixer configured to coherently mix the received reflected light signal with a local light signal and output a mixed light signal.

32. The apparatus of claim 31, wherein the electro-optical detector further comprises:
an electro-optical converter configured to convert the mixed light signal into the electronic data signal.

33. The apparatus of claim 31, further comprising:
a light source configured to generate the light signal and the local light signal.

34. The apparatus of claim 33, wherein the light source is a laser, and the apparatus is a lidar (light detection and ranging) apparatus.

35. The apparatus of claim 26, further comprising:
a code generator configured to generate the range measurement code and the light beam isolation code.

36. The apparatus of claim 26, wherein the electro-optical modulator is further configured to assign the light beam isolation code randomly.

37. The apparatus of claim 26, wherein the electro-optical modulator is further configured to reassign the light beam isolation code periodically.

38. The apparatus of claim 26, wherein the range measurement code is a pseudorandom number.

39. The apparatus of claim 26, wherein the light beam isolation code is an orthogonal code.

40. An autonomous system, comprising:
an electro-optical modulator configured to phase modulate a light signal with a range measurement code and a light beam isolation code;
an electro-optical detector configured to receive a reflected light signal of the phase modulated light signal reflected by an object, and convert the received reflected light signal into an electronic data signal; and
processing circuitry configured to correlate, the electronic data signal with the light beam isolation code and the range measurement code to obtain a range to the object.

41. The autonomous system of claim 40, wherein the processing circuitry is further configured to correlate the electronic data signal with the light beam isolation code to filter out any interfering signal, and then correlate this filtered result with the range measurement code to obtain the range.

42. The autonomous system of claim 41, wherein an energy peak of the correlated filtered result has a time delay corresponding with the range.

43. The autonomous system of claim 40, further comprising:
a first beam splitter configured to split the phase modulated light signal into a plurality of phase modulated light beam signals to be transmitted over respective channels; and
wherein by the electro-optical modulator is further configured to modulate the plurality of phase modulated light beam signals with a plurality of respective light beam isolation codes.

44. The autonomous system of claim 43, further comprising:
a second beam splitter configured to split a local light signal into a plurality of local light beam signals; and
a plurality of mixers, within the electro-optical detector, configured to mix respective reflected signals of the plurality of phase modulated light beam signals with the respective plurality of local light signals.

45. The autonomous system of claim 40, further comprising:
a mixer, of the electro-optical detector, configured to coherently mix the received reflected light signal with a local light signal and output a mixed light signal.
